(19) United States
(12) Patent Application Publication
(10) Pub. No.: US 2007/0055515 A1
(43) Pub. Date: Mar. 8, 2007

(54) Method for automatically matching graphic elements and phonetic elements

(75) Inventor: Edmond Lassalle, Lannion (FR)

Correspondence Address: LOWE HAUPTMAN BERNER, LLP, 1700 DIAGONAL ROAD, SUITE 300, ALEXANDRIA, VA, 22314, US

(73) Assignee: FRANCE TELECOM, Paris (FR)

(21) Appl. No.: 10/596,425

(22) PCT Filed: Dec. 17, 2004
(86) PCT No.: PCT/FR04/03278

§ 371 Date: Jun. 13, 2006

(30) Foreign Application Priority Data
Dec. 18, 2003 (FR) 0314928

(51) Int. Cl. G10L 15/06

(52) U.S. Cl. 704/243

(57) ABSTRACT

The invention derives automatically segmenting any graphic chain into graphemes and any phonetic chain into phonemes from transcriptions graphic chains (words) into phonetic chains. First probabilities (P(gᵢ|pⱼ)) of transcriptions of graphic elements into phonetic elements are estimated (E2). For each transcription of a given graphic chain with M graphic elements into a corresponding phonetic chain with N phonetic elements, second probabilities (P(g₁, . . . gₘ|p₁, . . . pₙ)) of MN second transcriptions of M graphic chains successively concatenating the M graphic elements into N phonetic chains successively concatenating the N phonetic elements are determined. Links between the last elements (gₘ, pₙ) of the graphic and phonetic chains of second transcriptions are established in order to constitute in an M×N matrix a path segmenting the given graphic chain into graphemes corresponding to respective phonemes segmenting the corresponding phonetic chain.

### REFERENCE TO RELATED APPLICATION

This application is a continuation of the PCT International Application No. PCT/FR2004/03278 filed Dec. 17, 2004, which is based on the French Application No. 0314928 filed Dec. 18, 2003.

### BACKGROUND OF THE INVENTION

1—Field of the Invention

The present invention relates generally to the automatic extraction of linguistic knowledges in a corpus of transcriptions of graphic chains into phonetic chains. It relates more particularly to the transcription of typographic elements such as characters in a predetermined language into phonetic elements.

2—Description of the Prior Art

At present, each word of a language constitutes a graphic chain that is transcribed phonetically into a chain of phonemes by a phonetician. For any new word to be added to a training corpus, the phonetician must intervene to transcribe the new word phonetically. Thus the training corpus furnishes only global grapheme/phoneme transcriptions. For example in the global transcription “ruelle”/[ryε1], the corpus indicates that, globally, the graphic chain “ruelle” is translated into a phonetic chain. However, it is not made explicit that the typographic element “r” is retranscribed phonetically in some unitary way. The global transcription does not indicate also the syllables or graphemes constituting the graphic chain and the phonetic elements constituting the phonetic chain.

One or more phonetic chains associated with any graphic chain can be determined from the known elementary transcription of each typographic element by character by character analysis of the graphic chain. Error corrector systems find the phonetic transcriptions useful for recognizing lexical errors in entering text on a keyboard. There is therefore a need to extract more refined elementary transcriptions from a raw transcription.

### OBJECT OF THE INVENTION

The invention aims to derive automatically from raw transcriptions of graphic chains, for example words and family names, into phonetic chains, transcriptions of graphic elements, for example characters, into phonetic elements constituting the phonetic chains, in order to segment any graphic chain into graphemes and any phonetic chain into phonemes automatically. The graphic element by graphic element, i.e. character by character, elementary transcriptions thereafter facilitate automatic global transcription of any additional graphic chain added to the corpus of graphic chains, in particular on the basis of a concatenation of phonetic elements matching on a one to one basis to the characters of the additional graphic chain.

### SUMMARY OF THE INVENTION

Accordingly, a method of the invention matches graphic elements constituting given graphic chains automatically to phonetic elements constituting corresponding phonetic chains after initially entering global transcriptions of the graphic chains into the phonetic chains into a database accessible by the computer and after estimating and storing in the database first probabilities of elementary transcriptions of graphic elements into respective phonetic elements. The method is characterized by the following steps:

for each transcription of a given graphic chain with M graphic elements into a corresponding phonetic chain with N phonetic elements, determining by M×N iterations second probabilities of M×N second transcriptions of M graphic chains resulting from M successive concatenations of 1 to M graphic elements into N phonetic chains resulting from N successive concatenations of 1 to N phonetic elements, each second probability of a second transcription depending on a preceding estimated first probability of last graphic and phonetic element of said second transcription and depending on the highest of three respective second probabilities determined by preceding iterations, M and N being integers, and

establishing and storing a link between the last elements of the graphic and phonetic chains of each second transcription and the last elements of the graphic and phonetic chains of the transcription relating to the highest of the three respective second probabilities in order for links established in an M×N matrix relative to the second probabilities to constitute a single path between last and first pairs of graphic and phonetic elements of the matrix in order to segment the given graphic chain into graphemes corresponding to respective phonemes segmenting the corresponding phonetic chain and to store the matches between the graphemes and phonemes in the database, the number of graphic elements in a grapheme being identical to the number of phonetic elements in the corresponding phoneme, in order for any new graphic chain to be transcribed automatically into a phonetic chain segmented into phonemes by means of the stored matches.

According to other features of the invention, the respective first probability for the determination of a second probability relating to a second transcription of a graphic chain concatenating m graphic elements into a phonetic chain concatenating n phonetic elements, with 1≦m≦M and 1≦n≦N, relates to the last elements in the graphic chain with m graphic elements and the phonetic chain with n phonetic elements. The three respective second probabilities determined beforehand for the second transcription of the graphic chain with m graphic elements into the phonetic chain with n phonetic elements preferably and respectively relate to a second transcription of a graphic chain with m-1 graphic elements into the phonetic chain with n phonetic elements, a second transcription of the graphic chain with m graphic elements into a phonetic chain with n-1 phonetic elements and a second transcription of the graphic chain with m-1 graphic elements into the phonetic chain with n-1 phonetic elements.

For example, the invention transcribes phonetically from the corpus of global transcriptions such as “ruelle”|[ryεl] the graphic elements “r”, “u”, “e”, “lle” into the respective phonetic elements [r], [y], [ε], [1].

The invention may be regarded as similar to a process of syllabation which, by analysis, decomposes a global transcription into elementary transcriptions and locally matches grapheme/phoneme subtranscriptions. The division into initial graphemes and phonemes and the biunivocal matching of each graphic element to each phonetic element of the divided phonemes is called grapheme|phoneme alignment. In the above example, the invention produces the following alignment:

| “r” | “u” | “e” | “lle” |
|---|---|---|---|
| [r] | [y] | [ε] | [l**]. |

The symbol * denotes a mute and meaningless phonetic element.

### BRIEF DESCRIPTION OF THE DRAWINGS

Other features and advantages of the present invention will become more clearly apparent from the reading of the following description of preferred embodiments of the invention, given by way of nonlimiting examples and with reference to the corresponding appended drawings, in which:

FIG. 1 shows an algorithm of the main steps of the automatic matching method of the invention; and

FIG. 2 shows an algorithm of the substeps of a step of the automatic matching method for determining individual first probabilities.

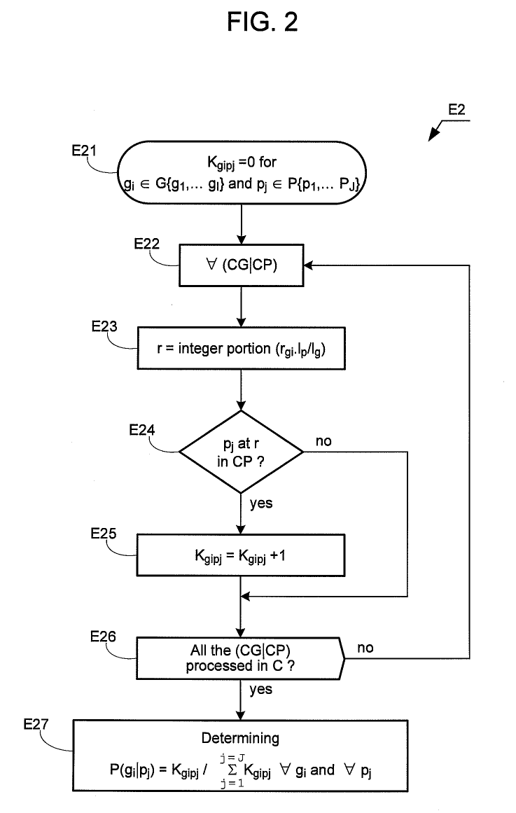

### DETAILED DESCRIPTION OF THE DRAWINGS

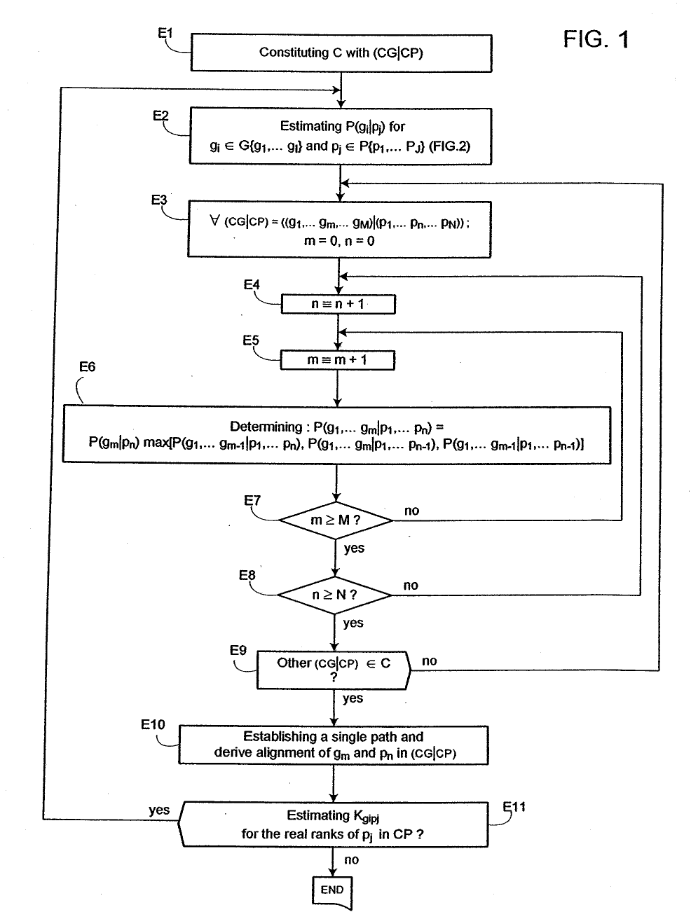

As shown in FIG. 1, the method of the invention for automatically matching graphic elements and phonetic elements comprises main steps E1 to E11. For example, those steps are for the most part implemented in the form of software in a terminal, such as a personal computer or a mobile in a cellular radio communication network, and linked in particular to software system for orthographic correction of lexical errors which is insertable into a word processing system or a linguistic practice system. The terminal contains or is able to access a database of the type used in artificial intelligence. The database stores a corpus C of initial global transcriptions.

Initially, in the step E1, the global transcriptions (CG|CP) are constituted by pairs each matching a graphic chain CG such as a word in a predetermined language or a family name to a phonetic chain CP. These transcriptions are determined and entered by an expert in phonetics on a form displayed by the computer. The corpus C matches a priori graphic chains GC each composed of one or more typographic elements (characters) hereinafter called graphic elements gᵢ of an alphabet G={g₁, . . . , gⱼ} with I elements in the predetermined language, where 1≦i≦M, to respective phonetic chains CP each composed of one or more phonetic elements pⱼ of an alphabet P={p₁, . . . , pⱼ} with J phonetic elements, where 1≦j≦J and I≠J. However, the segmentation of the chain CG into syllables or into graphemes each comprising one or more graphic elements and the segmentation of the chain CP into phonemes each comprising one or more phonetic elements are ignored at this stage.

The alphabets G and P typically comprise around 30 elements. There are therefore a total of 30×30=900 possible pairs of graphic elements and phonetic elements. In practice, the corpus C contains at least 100 000 global transcriptions of typographic chains CG into phonetic chains CP, which protects the invention from coarse errors in the estimation of probabilities, as discussed below.

In the step E2, first probabilities of elementary transcription P(gᵢ|pⱼ) such that a graphic element gᵢ matches the phonetic element pⱼ are firstly estimated and stored in the database with the corpus C of global transcriptions.

The estimated values of the first probabilities are as far as possible close to respective maximum probability values required for the method of the invention operating by iterations to converge quickly without retaining local maxima.

The concatenated nature of the global transcriptions of the chains leads to the hypothesis of a correlation between the rank r_{g} of the graphic elements in a graphic chain CG and the rank rₚ of the phonetic elements in the corresponding phonetic chain CP. For example, in the global transcription (beau|bo), it is more probable that the graphic element b, given its position at the beginning of the chain CG, translates to a phonetic element [b] rather than a phonetic element [o] placed at the end of the corresponding chain CP. In this example, the correlation of the ranks moves the graphic elements [b] and [e] of the phonetic element [b] and the graphic elements [a] and [u] of the phonetic element [o] closer together.

The algorithm for the initial estimation E2 of the first probabilities P(gᵢ|pⱼ) comprises the following substeps E21 to E27.

In the substep E21, IJ contingency numbers K_{gipj} respectively associated with the elementary transcriptions (gᵢ|pⱼ) of a graphic element of the alphabet G and a phonetic element of the alphabet P are set to zero. The contingency number K_{gipj} is equal at the end of the step E2 to the estimated number of times that the graphic element gᵢ is retranscribed into the phonetic element pⱼ in the various global transcriptions of typographic chains CG into phonetic chains CP included in the corpus C.

For each chain transcription (CG|CP), as indicated in the substep E22, the ranks of the graphic elements in the chain CG and the ranks of the phonetic elements in the chain CP are normalized as a function of the respective lengths l_{g} and lₚ of the chains CG and CP, which may be different. In the substep E23, the rank r of a phonetic element in the chain CP is derived from the rank r_{gi} of a graphic element gᵢ in the chain CG with which the phonetic element of rank r will be associated, in accordance with the following relationship:
r=integer portion (r_{gi}·lₚ/l_{g})

The number K_{gipj} of contingencies associated with the elementary transcription of the graphic element gᵢ into the phonetic element pⱼ is then incremented by 1 only if the phonetic element pⱼ is situated at the derived rank r in the chain CP, as indicated in the substeps E24 and E25.

The substeps E22 to E25 are repeated for each global transcription (CG|CP) of the corpus C, as indicated in the substep E26. When all the global transcriptions of the corpus have been processed, the next substep E27 estimates all the first probabilities P(gᵢ|pⱼ) of elementary transcription between the graphic elements and the phonetic elements, in accordance with the following relationship for each graphic element gᵢ:

$$P ( {g}_{i} \vert {p}_{j} ) = {K}_{gipj} / {\sum }_{j = 1}^{j = J} {K}_{gipi}$$

after calculating the sum term in the denominator for the graphic element gᵢ.

Referring again to FIG. 1, the matching process continues with steps E3 to E10 which segment each graphic chain CG read in the corpus of the database in order to match automatically and on a biunivocal basis each segment of the chain CG, called a grapheme, comprising one or more graphic elements, to a segment, called a phoneme, comprising one or more phonetic elements resulting from segmentation of the corresponding phonetic chain CP.

A graphic chain CG comprises M consecutive graphic elements g₁ to g_{M} and the phonetic chain CP corresponding to the chain CG comprises N consecutive phonetic elements p₁ to P_{N}. The integer N may be different from or equal to the integer M.

The probability P(g₁, . . . gₘ, . . . g_{M}|p₁, . . . Pₙ, . . . P_{N}) that the chain CG matches the chain CP, where 1≦m≦M and 1≦n≦N, is determined as a function of the first elementary transcription probabilities P(gᵢ|pⱼ) estimated and stored beforehand in the step E2 and from similarity between the chains CG and CP. The similarity is based on the Damerau-Levenshtein Metric (DLM) but using maximization instead of minimization. The probability P(CG|CP) is determined by dynamic programming using the following iterative formula for any pair m,n such that 1≦n≦N and 1≦m≦M:
P(g₁g₂. . . gₘ|p₁p₂. . . pₙ)=P(gₘ|pₙ)max [P(g₁g₂. . . gₘ₋₁|p₁p₂. . . pₙ), P(g₁g₂. . . gₘ|p₁p₂. . . pₙ₋₁), P(g₁g₂. . . gₘ₋₁|p₁p₂. . . pₙ₋₁)].

The concatenated nature of the global chain transcriptions and the grapheme/phoneme transcriptions means that Markov models may be applied efficaciously. For the given probability of transcription of a chain g₁,g₂. . . gₘ into a chain p₁p₂. . . pₙ, the extension of the graphic, respectively phonetic, chain by a new graphic element gₘ₊₁, respectively phonetic element pₙ₊₁, gives rise either to the same phonetic chain, respectively graphic chain, or to the addition of a new phonetic element, respectively graphic element. Expressed in terms of probability, P(g₁g₂. . . gₘ₊₁|p₁p₂. . . pₙ₊₁) depends only on the probabilities of three possible transcriptions:
P(g₁g₂. . . gₘ|p₁p₂. . . pₙ₊₁),
P(g₁g₂. . . gₘ₊₁|p₁p₂. . . pₙ),
P(g₁g₂. . . gₘ|p₁p₂. . . pₙ).

That dependency is expressed by the DLM metric equal to the highest of the above three possibilities.

After setting the indices m and n to zero for a global transcription (CG|CP) in the step E3 and incrementing the indices m and n by 1 in the steps E4 and E5, iterations in the steps E6 and E7 begin by determining the probabilities so that the M successive concatenations of the graphic elements g₁ to gₘ of the chain CG match the first phonetic element p₁ of the chain CP, i.e.:
P(g₁, . . . gₘ|p₁)=P(gₘ|p₁) max[P(g₁. . . gₘ₋₁|p₁)]
where 1≦m≦M, and starting with the elementary probability P(g₁|p₁). As shown by the step E8, the process then determines by iteration the probabilities of the M concatenations of the graphic elements g₁ to gₘ of the chain CG matching the first two phonetic elements p₁ and p₂ of the chain CP using the probabilities previously determined for the first graphic element p₁, i.e.:
P(g₁, . . . gₘ|p₁, p₂)=P(gₘ|p₂) max [P(g₁, . . . gₘ₋₁|p₂), P(g₁, . . . gₘ|p₁), P(g₁, . . . gₘ₋₁|p₁)].

The process then continues by adding a phonetic element pₙ to determine the M probabilities P(g₁|p₁, . . . pₙ) to P(g₁, . . . , g_{M}|p₁, . . . pₙ) up to the M probabilities relating to the chain CP=(p₁, . . . p_{N}) By iteration of the steps E4 to E8, the computer progressively constructs and stores a matrix of second probabilities P(g₁, . . . gₘ|p₁, . . . pₙ) with M columns for successive concatenations of the M graphic elements and N rows for successive concatenations of the N phonetic elements, operating row by row as in the above example, beginning with the probability P(g₁|p₁) and ending with the probability P(g₁, . . . g_{M}|p₁, . . . p_{N}).

Each iteration relating to the (m·n)^{th} transcription [(g₁, . . . gₘ)|(p₁, . . . pₙ)] establishes a link between the pair (gₘ,pₙ) and the pair with the highest of the three probabilities determined beforehand for the three pairs (gₘ₋₁,pₙ), (gₘ,pₙ₋₁) and (gₘ₋₁,pₙ₋₁). The link is stored in the computer. If the pair (gₘ,pₙ) is linked to the pair (gₘ₋₁,pₙ), it is an elementary transcription from (gₘ₋₁, gₘ) to pₙ; if the pair (gₘ,pₙ) is linked to the pair (gₘ,pₙ₋₁), it is an elementary transcription from gₘ to (pₙ₋₁,pₙ); if the pair (gₘ,pₙ) is linked to the pair (gₘ₋₁,pₙ₋₁), it is an elementary transcription from gₘ to pₙ.

Thus a link is stored in the computer for each determination of a probability P(g₁, . . . gₘ)|(p₁, . . . pₙ). The links trace a single path that is also stored progressively in the computer and links the first pair (g₁, p₁) to the last pair (g_{M}, p_{N}) in the matrix with M columns and N rows. The topology of the single path in the M×N matrix segments the graphic chains CG into graphemes and the phonetic chains CP into phonemes and aligns the graphic elements and the phonetic elements in biunivocal correspondence. If a segment of the path follows a portion of a row between two graphic elements, the concatenation of the graphic elements of that row portion corresponds to the phonetic element of the row completed by one or more mute and meaningless phonetic elements in order to form a grapheme and phoneme pair that has the same number of elements and is stored in the computer. If a segment of the path follows a column portion between two phonetic elements, the graphic element of the column plus one or more meaningless graphic elements corresponds to the concatenation of the phonetic elements of that column portion in order to form a grapheme and phoneme pair that has the same number of elements and is stored in the computer. A change of direction of the path in the matrix towards the horizontal, the vertical or the diagonal indicates segmentation of the chains CG and CP.

A simple example concerns seeking to segment the global transcription of the word CG=“beau” into the phonetic chain CP=[bo] on the assumption that the step E2 estimated the following first individual probabilities in the corpus C:
P(b|b)=0.9; P(e|b)=0.1; P(a|b)=0.1; P(u|b)=0.1 P(e|o)=0.2; P(a|o)=0.1; P(u|o)=0.2; P(b|o)=0.1.

For the transcription (beau|bo) from the corpus, the M=4 iterations of the steps E5, E6 and E7 for each of the N=2 rows of the 4×2 matrix produce the following table:

| pₙ/gₘ | b = g₁ | e = g₂ | a = g₃ | u = g₄ |
|---|---|---|---|---|
| [b] = p₁ | 0.9 | [symbol] 0.09 | [symbol] 0.09 | [symbol] 0.0009 |
| [o] = p₂ | ↑0.09 | [symbol] 0.18 | [symbol] 0.018 | [symbol] 0.0036 |
| The symbol [symbol] indicates that the pair (gₘ, pₙ) is linked to the pair (gₘ₋₁, pₙ); the symbol ↑ indicates that the pair (gₘ, pₙ) is linked to the pair (gₘ, pₙ₋₁); and the symbol [symbol] indicates that the pair (gₘ, pₙ) is linked | | | | |
| # to the pair (gₘ₋₁, pₙ₋₁). The symbol [symbol] associated with the transcription (be\|bo) indicates that the latter has been derived and is therefore linked to the preceding transcription (b\|b). The symbol [symbol] indicates a segmentation boundary between grapheme and phoneme pairs. | | | | |

The following alignment is derived from this table:
b eau
b o**.
The symbol * designates a mute and meaningless phonetic element.

To perfect the matches between graphemes and phonemes and the matches between graphic elements and phonetic elements, preferably in the manner indicated by the step Eli, the first probabilities P(g₁|p₁) to P(g_{I}|p_{J}) of the transcriptions of each of the graphic elements respectively into the J phonetic elements (step E2) and in particular the contingency numbers K_{g1p1} to K_{gIpJ} (substep E25) are again estimated as a function in particular of the ranks of the phonetic elements placed in the given phonetic chains CG that were segmented into phonemes in the preceding step E10. Second probabilities P(g₁, . . . gₘ|p₁, . . . pₙ) of M×N second transcriptions of each global transcription of a given graphic chain with M graphic elements (CG) into a corresponding phonetic chain (CP) with N phonetic elements are determined by executing the steps E3 to E10 in order for links to be established in the next step E10 between pairs (gₘ,pₙ) of a new matrix with M columns and N rows and consequently for a corrected path to link the last pair (g_{M},p_{N}) to the first pair (g₁,p₁) in the new M×N matrix of second probabilities.

Thanks to the processing capacity and high processing speed of the computer, other iterative loops of steps E2 to E11 may be executed in the computer until the matching process converges, i.e. until the path established becomes constant from one loop to the next.

After segmentation of all the graphic and phonetic chains of the corpus G into graphemes and phonemes, the database stores all matches between graphic and phonetic elements and all matches between graphemes and phonemes for the whole of the processed corpus C.

Any new graphic chain added to the corpus can then be transcribed automatically into a phonetic chain segmented into phonemes, in particular with the aid of the matches previously established and stored in accordance with the invention, which progressively enriches the corpus in the database and increases transcription accuracy.

As already stated, the phonetic transcriptions are useful to orthographic error correction software systems that recognize lexical errors when entering text on a terminal keyboard. Thus when the new graphic chain added to the corpus is being entered on a terminal keyboard, the phonetic chain segmented into phonemes by means of the stored matches is used for orthographic correction of the new graphic chain entered.

The method of the invention may equally well be used as a tool for automatically generating SMS short messages from a text written in ordinary language. This necessitates a training corpus C the transcriptions whereof are adapted to the automatic generation of SMS messages and respectively match graphic chains CG, such as words and phrases, to phonetic chains CP whose “phonemes” are phonetically readable by any person who is not an expert in phonetics. For example, the corpus establishes the following matches (in French) between graphic chains and phonetic chains:

j′ai:G

air:R

occupé:OQP

cas:K.

Thus a new graphic chain entered in a terminal is automatically transcribed by the method of the invention into a phonetic chain segmented into phonemes that can be read by any person who is not an expert in phonetics by means of stored matches to be included in an SMS message. In the foregoing example, the French phrase “j′ai l′air occupé” entered on the terminal is transcribed automatically into the following short message to be transmitted by the terminal: Gl′ROQP, the “phonetic chains” [G], [l′], [R] and [OQP] being phonetically readable by any user who is not an expert in phonetics. Alternatively, the phonetic chains [G], [l′], [R] and [OQP] may be treated as phonetic elements to constitute a phonetic chain [Gl′ROQP].

The steps of a preferred embodiment of the method of the invention are determined by instructions of a computer program incorporated into a computer such as a terminal, a personal computer, a server or any other electronic data processing system. The program automatically matches graphic elements constituting given graphic chains to phonetic elements constituting corresponding phonetic chains, after initially entering global transcriptions of the graphic chains into the phonetic chains into a database accessible to the computer and estimating and storing in the database first probabilities of elementary transcriptions of graphic elements into respective phonetic elements. The program includes program instructions which execute the steps of the method of the invention when said program is loaded into and executed in the computer, the operation whereof is then controlled by executing the program.

Consequently, the invention applies equally to a computer program adapted to implement the invention, in particular a computer program on or in an information medium. This program may use any programming language and take the form of source code, object code or an intermediate code between source code and object code, such as a partially compiled form, or any other form that may be desirable for implementing the method of the invention.

1. A method implemented in a computer for automatically matching graphic elements Re+constituting given graphic chains automatically to phonetic constituting corresponding phonetic chains, said method including the following steps
entering global transcriptions of said graphic chains into said phonetic chains into a database accessible by said computer,
estimating and storing in said database first probabilities of elementary transcriptions of graphic elements into respective phonetic elements,
for each transcription of a given graphic chain with M graphic elements into a corresponding phonetic chain with N phonetic elements, determining by M×N iterations second probabilities of M×N second transcriptions of M graphic chains resulting from M successive concatenations of 1 to M graphic elements into N phonetic chains resulting from N successively concatenation of 1 to N phonetic elements, each second probability of a second transcription depending on a preceding estimated first probability of last graphic and phonetic element of said second transcription and depending on the highest of three respective second probabilities determined by preceding iterations M and N being integers, and
establishing and storing a link between Blast elements of the graphic chain and phonetic chains of each second transcription and last elements of the graphic chain and phonetic chain* of the transcription relating to said highest of said three respective second probabilities in order for links established in an M×N matrix relative to said second probabilities to constitute a single path between last and first pairs of graphic and phonetic elements of said matrix in order to segment said given graphic chain into graphemes corresponding to respective phonemes segmenting the corresponding phonetic chain and to store the matches between said graphemes and phonemes in said database, the number of graphic elements in a grapheme being identical to the number of phonetic elements in the corresponding phoneme, in order for any new graphic chain to be transcribed automatically into a phonetic chain segmented into phonemes by means of the stored matches.

2. A method according to claim 1, wherein said respective first probability for the determination of a second probability relating to a second transcription of a graphic chain concatenating m graphic elements into a phonetic chain concatenating n phonetic elements, with 1≦m≦M and 1≦n≦N, relates to the last elements in the graphic chain with m graphic elements and the phonetic chain with n phonetic elements.

3. A method according to claim 1, wherein said three respective second probabilities determined beforehand for said second transcription of the graphic chain with m graphic elements into the phonetic chain with n phonetic elements respectively relate to a second transcription of a graphic chain with m−1 graphic elements into the phonetic chain with n phonetic elements, a second transcription of the graphic chain with m graphic elements into a phonetic chain with n−1 phonetic elements and a second transcription of the graphic chain with m−1 graphic elements into the phonetic chain with n−1 phonetic elements.

4. A method according to claims 1, comprising estimating other first probabilities of transcriptions of each of said graphic elements respectively into said phonetic elements as a function in of the ranks of said phonetic elements placed in said given phonetic chains that were segmented into phonemes, in order again to determine second probabilities of M×N second transcriptions of each transcription of a given graphic chain with M graphic elements into a corresponding phonetic chain with N phonetic elements and to establish a corrected path linking the last pair to the first pair in a new M×N matrix of second probabilities.

5. A method according to any one of claims 1, wherein said new graphic chain is being entered on a terminal keyboard and said phonetic chain segmented into phonemes by means of said stored matches is used for orthographic correction of said new graphic chain entered.

6. A method according to claims 1, wherein said phonetic chains are phonetically readable by any person who is not an expert in phonetics, and said new graphic chain is automatically transcribed into a phonetic chain segmented into phonemes that can be read by any person who is not an expert in phonetics by means of stored matches to be included in a short message.

7. A computer program adapted to be executed in a computer for automatically matching graphic elements (gi)constituting given graphic chains automatically to phonetic elements constituting corresponding phonetic chains after initially entering global transcriptions of the graphic chains into the phonetic chains into a database accessible by the computer and after estimating and storing in the database first probabilities of elementary transcriptions of graphic elements into respective phonetic elements, said program including program instructions which execute the following steps when the program is loaded into and executed in the computer:
for each transcription of a given graphic chain with M graphic elements into a corresponding phonetic chain with N phonetic elements, determining second probabilities of MN second transcriptions of M graphic chains successively concatenating the M graphic elements into N phonetic chains successively concatenating the N phonetic elements, each as a function of a respective first probability and of the highest of three respective second probabilities determined beforehand, and
establishing and storing a link between the last elements of the graphic and phonetic chains of each second transcription and the last elements of the graphic and phonetic chains of the transcription relating to the highest of the three respective second probabilities in order for the links established in an M×N matrix relative to the second probabilities to constitute a single path between last and first pairs of graphic and phonetic elements of the matrix in order to segment the given graphic chain into graphemes corresponding to respective phonemes segmenting the corresponding phonetic chain and to store the matches between the graphemes and phonemes in the database, the number of graphic elements in a grapheme being identical to the number of phonetic elements in the corresponding phoneme, in order for any new graphic chain to be transcribed automatically into a phonetic chain segmented into phonemes by means of the stored matches.
